(19) United States
(12) Patent Application Publication
(10) Pub. No.: US 2026/0089759 A1
(43) Pub. Date: Mar. 26, 2026

(54) RANDOM ACCESS CHANNEL (RACH) CONFIGURATION ADAPTATION DURING A RACH PROCEDURE

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Navid ABEDINI, Basking Ridge, NJ (US)

(21) Appl. No.: 18/892,249

(22) Filed: Sep. 20, 2024

(51) Int. Cl. H04W 74/0833; H04W 72/231

(52) U.S. Cl. CPC H04W 74/0833; H04W 72/231

(57) ABSTRACT

Certain aspects of the present disclosure provide techniques for random access channel (RACH) configuration adaptation during a RACH procedure. A method generally includes receiving an indication of a RACH configuration associated with one or more first RACH occasions (ROs); sending, in a first RO of the one or more first ROs, a first random access signal to initiate a first RACH procedure; and receiving a random access response-related message comprising a RACH configuration adaptation indication associated with one or more second ROs.

### INTRODUCTION

### Field of the Disclosure

Aspects of the present disclosure relate to wireless communications, and more particularly, to techniques for random access communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving an indication of a random access channel (RACH) configuration associated with one or more first RACH occasions (ROs); sending, in a first RO of the one or more first ROs, a first random access signal to initiate a first RACH procedure; and receiving a random access response-related message comprising a RACH configuration adaptation indication associated with one or more second ROs.

Another aspect provides a method for wireless communication by a network entity. The method includes sending an indication of a RACH configuration associated with one or more first ROs; receiving, in a first RO of the one or more first ROs, a first random access signal to initiate a first RACH procedure; and sending a random access response-related message comprising a RACH configuration adaptation indication associated with one or more second ROs.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example four-step random access channel (RACH) procedure.

FIG. 5B depicts an example two-step RACH procedure.

FIGS. 6A-6B depict example process flows for communications in a network between a network entity and a UE to adapt a RACH configuration.

FIG. 7 depicts an example process flow for communications in a network between a network entity and a UE to adapt a RACH configuration.

FIGS. 8A-8C depict example process flows for communications in a network between a network entity and a UE to adapt a RACH configuration for a limited period of time.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for (e.g., dynamically) adapting a random access channel (RACH) configuration identifying random access occasion (ROs) corresponding to time-frequency resources configured for random access communications. As described in detail below, a RACH configuration adaptation indication may be included in a random access response-related message (e.g., a random access response message, such as MSG2 or MSGB, or a downlink control information (DCI) scheduling the random access response message) sent during a RACH procedure. The RACH configuration adaptation indication may indicate the activation of an adaptation associated with one or more ROs. Activation of the adaptation may (e.g., dynamically) adjust the RO(s) available for random access communications, such as for communicating a subsequent random access signal (also commonly referred to as “a random access preamble,” “a preamble,” “a first message,” “MSG1,” and/or “MSGA”).

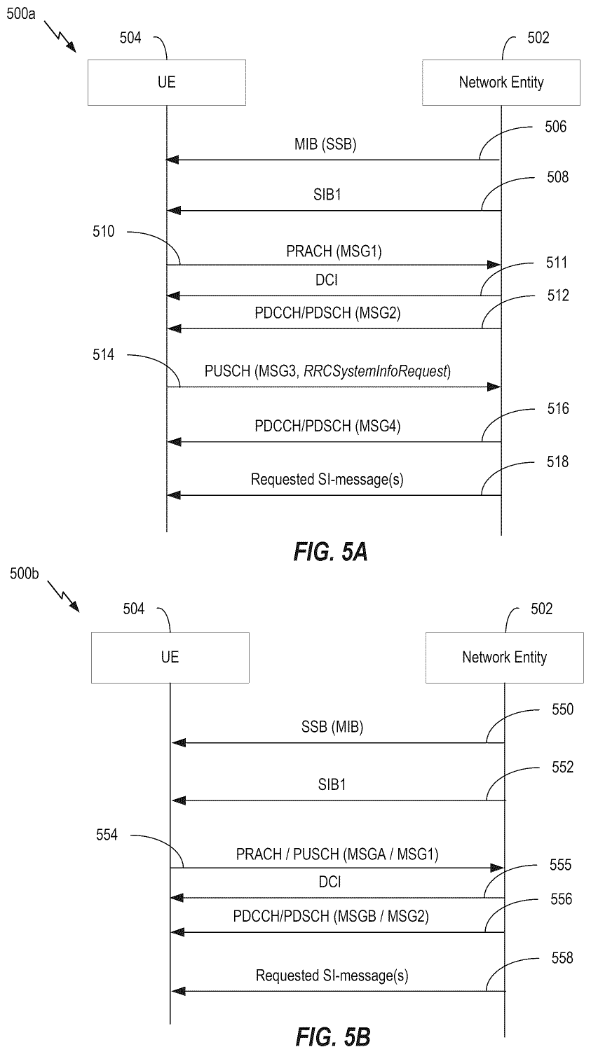

In certain wireless communication systems (e.g., 5G New Radio systems and/or any future wireless communications system), a user equipment (UE) may communicate with a network entity (e.g., a base station (BS)) using a random access procedure, also referred to herein as a “RACH procedure,” for example, for initial access to the network entity, for beam failure recovery, to obtain timing information (e.g., a timing advance), to request uplink communication resources, to request system information, etc. An example RACH procedure may begin with the UE sending a random access signal (e.g., preamble) on a physical RACH (PRACH) in an RO, which may include one or more time-frequency resources. Upon successful reception of the random access signal, the network entity may send a response (referred to as a random access response) to the random access signal within a random access response window (e.g., a time window). For example, in certain aspects, the network entity may send a physical downlink control channel (PDCCH) communication including DCI that schedules the random access response on a physical downlink shared channel (PDSCH). The random access response may include an uplink scheduling grant. On receiving the response, the UE may send a request to setup a connection with the network entity, and then, the network entity may reply with a contention resolution response. Certain aspects associated with random access communications are further described herein, for example, with respect to FIGS. 5A and 5B.

In certain aspects, a UE obtains, from a network entity, a configuration for random access communications (also referred to herein as a “RACH configuration”), such as to perform a RACH procedure, via system information that is broadcast by the network entity. The RACH configuration may identify certain parameters for random access communications, such as a set of preambles and/or a duration for the random access response window. Further, in certain aspects, the RACH configuration may identify ROs corresponding to time-frequency resources configured for random access communications, such as for a random access signal transmission (e.g., preamble transmission) from the UE to the network entity.

In certain aspects, the network entity may determine to reconfigure a RACH configuration for random access communications, for example, in response to time varying traffic levels, in response to changes to network capacity, based on collisions of transmissions from UEs in a same RO, and/or to increase reduce energy consumption for the network entity and/or the UE.

For example, the network entity may determine to reconfigure the RACH configuration for the UE to reduce energy consumption at the network entity (and/or the UE), such as when a traffic level associated with traffic intended for the UE is low. The network entity may reconfigure the RACH configuration to increase the periodicity for ROs configured for random access communications to reduce an RO frequency. The reduced RO frequency may allow for increased energy savings at the network entity, as the network entity may need to monitor less ROs over a given timeframe.

As another example, the network entity may determine to reconfigure the RACH configuration for the UE in response to an increase in network capacity (e.g., an increase in the amount of data that can be transmitted across a network within a given timeframe). This increase in network capacity may enable the network entity to configure additional RO(s) for random access communications between the UE and the network entity, thereby decreasing RO periodicity and increasing RO frequency. The increase in RO frequency may enable the UE to send random access signals more frequently, such as to help reduce the latency associated with establishing a radio resource control (RRC) connection with the network entity.

As another example, the network entity may determine to reconfigure the RACH configuration for the UE based on collisions of random access signals from multiple UEs in a same RO. For example, the network entity may reconfigure a RACH configuration for a UE to adjust ROs available to the UE for sending a random access signal to initiate a RACH procedure. The reconfiguration may adjust the RO(s) such that one or more RO(s) configured to be used by the UE are different than RO(s) configured to be used by another UE for random access communications.

As discussed, random access communications may be configured via system information. Such system information may be communicated by a network entity on a periodic basis, for example, with a periodicity that can be as long as 160 milliseconds (ms). In certain cases, the network entity may notify UEs via downlink control information (DCI) that the system information, which includes the RACH configuration, has been modified. This notification may trigger a UE to obtain the updated system information in the next transmission occasion for the system information, which may be as long as 160 ms. Accordingly, updating the RACH configuration for random access communications may use a non-trivial amount of time due to the updating procedure depending on the periodicity of system information to convey the updated RACH configuration.

In some techniques, to overcome the aforementioned technical problems associated with using system information for communicating RACH re-configurations, such as RO adjustments for sending random access signals, dynamic re-configuration of random access communications may be enabled. For example, a UE may obtain a dynamic indication of a RACH reconfiguration, such as via paging signaling (e.g., including a paging early indicator (PEI)). The dynamic RACH reconfiguration indication may be used to trigger the adjustment of ROs corresponding to time-frequency resources configured for random access communications (e.g., random access signal transmission), such as those ROs originally communicated to the UE in system information.

Dynamic RACH reconfiguration, for adjusting ROs, via paging signaling, may allow the network entity to reconfigure a RACH configuration for a UE based on various conditions, such as those conditions described above. This technique may rely on the network entity to determine when a RACH reconfiguration is needed to trigger sending the RACH reconfiguration indication to the UE (e.g., via the paging signaling). The network entity may not know when a UE is going to perform a RACH procedure; thus, in some cases, transmission of a RACH reconfiguration indication to the UE, by the network entity, may be wasteful. For example, the network entity may send a RACH reconfiguration indication to the UE to adapt RO(s) used for random access communications over a time period, such as to account for changes in traffic levels and/or network capacity over the time period. The UE may not initiate any RACH procedure during the time period; thus, the transmission of the RACH reconfiguration indication to the UE may unnecessarily increase transmission overhead in the network.

As such, certain aspects herein provide techniques to send an indication of an RO adaptation (e.g., a RACH reconfiguration), after the UE has initiated a RACH procedure. In certain aspects, the RO adaptation, sent during a RACH procedure, may help to increase the frequency of ROs for sending a subsequent random access signal should the initiated RACH procedure fail.

Aspects of the present disclosure enable RACH configuration adaptation, such as to adapt ROs corresponding to time-frequency resources configured for random access communications. For example, a RACH configuration adaptation indication may be included in a random access response-related message corresponding to a random access signal, sent by a UE, to initiate a RACH procedure. Thus, the RACH configuration adaptation indication may be sent to a UE during a RACH procedure. The RACH configuration adaptation indication may indicate an activation of an adaptation associated with one or more ROs. The RO(s) associated with the adaptation may include RO(s) previously identified to be available to the UE for random access communications (e.g., in an initial RACH configuration) and/or RO(s) which were not previously identified to be available to the UE for random access communications (e.g., in the initial RACH configuration). In certain aspects, the activation of the adaptation associated with the RO(s) may activate the RO(s), such that the RO(s) can be used for subsequently sending a random access signal. In certain aspects, the activation of the adaptation associated with the RO(s) may deactivate, or mute, the RO(s), such that the RO(s) cannot be used for subsequently sending a random access signal. In certain aspects, the activation of the adaptation associated with the RO(s) may activate a first subset of the ROs and deactivate a second subset of the ROs. In certain aspects, the UE receiving the RACH configuration adaptation indication may assume that the adaptation is valid until one or more conditions are met, such as (1) the UE establishes an RRC connection with the network entity, (2) a period of time has passed since receiving the RACH configuration adaptation indication in the random access response-related message, and/or (3) the UE receives an indication of deactivation of the adaptation.

Certain techniques for RACH configuration adaptation, during a RACH procedure, described herein may provide various beneficial technical effects and/or advantages. The techniques for RACH configuration adaptation, and more specifically RO adaptation for random access communications, may provide an effective technique for adapting available RO(s) at a UE in response to various conditions, such as changes in wireless traffic levels, network loads, and/or network energy consumption over time, to name a few. The RACH configuration adaptation enabled via a RACH configuration adaptation indication in a random access response-related message, as described herein, may help to reduce overhead transmission in the network by sending the adaptation indication only after a RACH procedure has been initiated (e.g., which may be more efficient than the network entity determining when to send the adaptation indication). Further, by sending the RACH configuration adaptation indication in the random access response-related message, a UE may not need to monitor additional signaling for the adaptation indication (e.g., such as paging signaling), and the network entity may not need to send such signaling. As such, energy may be saved at the UE and the network entity.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

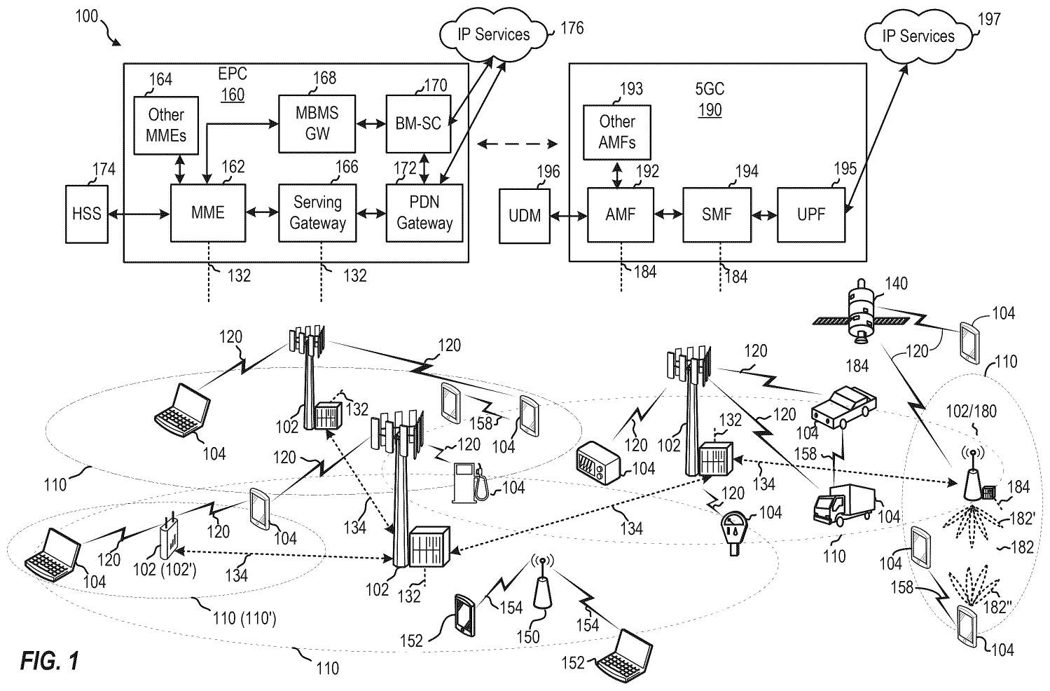

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

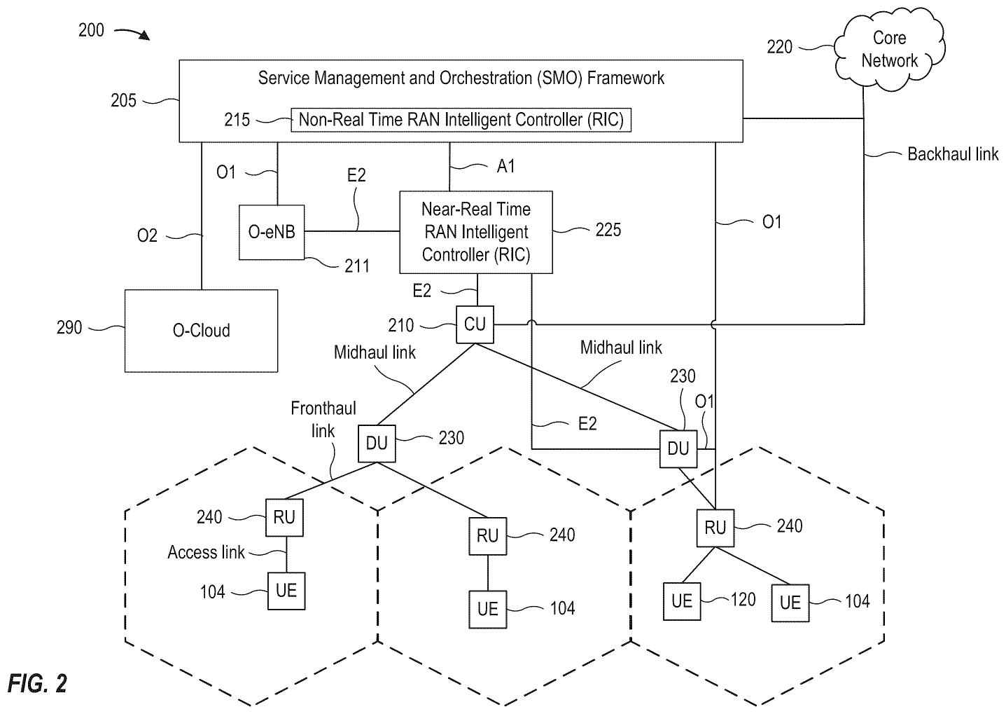

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

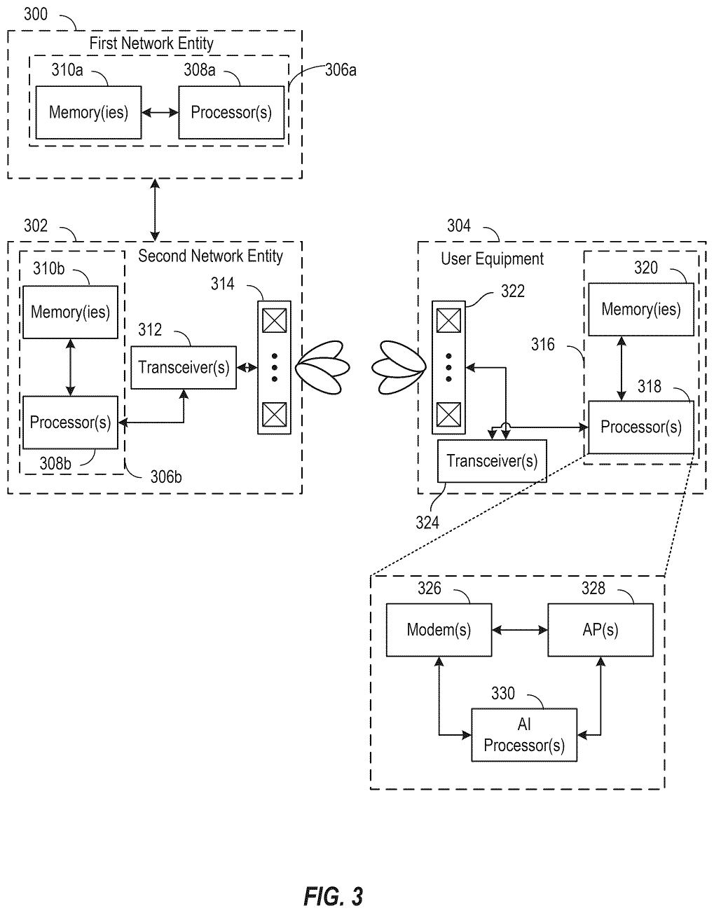

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

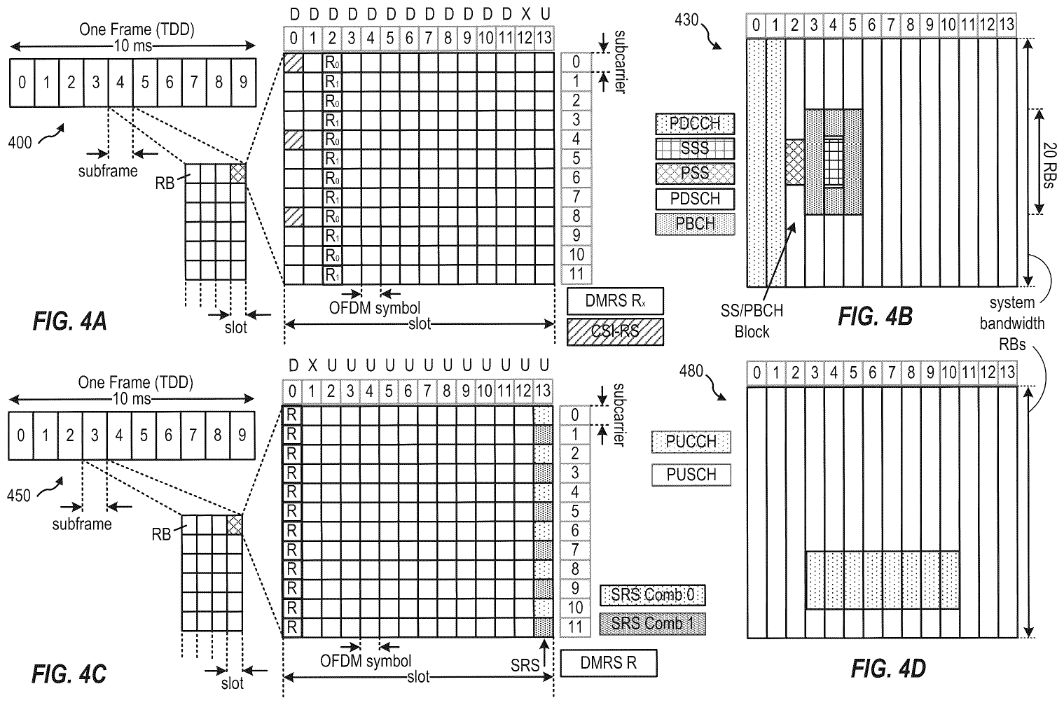

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example RACH Procedures

Certain wireless communication systems (e.g., a 5G NR system and/or any future wireless communications system) may provide a specified channel for random access, such as a RACH, and corresponding random access procedures, also referred to herein as “RACH procedures.” A RACH procedure may be performed for any of various events including, for example, initial access from an idle state, RRC connection re-establishment, handover, downlink and/or uplink data arrival (e.g., when the UE is in an idle state), or device positioning.

As used herein, RRC states of a UE in a RAN include (1) a connected state (also referred to as a “connected mode,” “RRC connected mode,” and/or “RRC connected state”), (2) an inactive state (also referred to as an “inactive mode,” “RRC inactive mode,” and/or “RRC inactive state”), and (3) an idle state (also referred to as an “idle mode,” “RRC idle mode,” and/or “RRC idle state”). The UE may be operating in a connected state in the RAN after establishing an RRC connection with a network entity in the RAN. The UE may be operating in an idle state in the RAN when the UE is not connected, or in other words, does not have an established RRC connection with the network entity in the RAN. The UE may be operating in an inactive state in the RAN when the UE has an established RRC connection with the network entity in the RAN, but the connection is in a dormant, suspended, or inactive and there is no active communication between the UE and the network entity. For example, while operating in the inactive state, unlike the idle state, a non-access stratum (NAS) layer of an RRC connection established by the UE may continue to be connected.

FIG. 5A depicts a process flow diagram of an example RACH procedure 500a (referred to as a “four-step RACH procedure”) performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may begin, at 506, with the network entity 502 broadcasting and the UE 504 receiving an MIB. The MIB may be carried by the PBCH, which, as described above, may be logically grouped with a PSS and a SSS to form a SS/PBCH block, and in some cases, referred to as an SSB. The MIB may be the first, among other SIBs, which may also be broadcasted by network entity 502. The MIB may be a control channel message transmitted by network entity 502 that provides information for UE 504 to synchronize with the network and access a cell of network entity 502. Network entity 502 may transmit MIBs periodically.

The RACH procedure 500a then proceeds, at 508, with the network entity 502 broadcasting and the UE 504 receiving a SIB1. The SIB1 may carry basic information that UE 504 may use to perform initial attachment to the RAN and network entity 502.

At 510, the UE 504 sends a first message (MSG1) to the network entity 502 on a physical random access channel (PRACH). In some aspects, MSG1 may indicate or include a RACH preamble. The RACH preamble may indicate or include a preamble signature associated with the RACH preamble. The preamble signature may correspond to a particular preamble sequence (e.g., a Zaddoff Chu sequence) generated across time-frequency resources used for the preamble transmission. For contention-based random access (CBRA), the preamble sequence may be randomly selected among a set of preamble sequences (e.g., up to 64 sequences in some cases). The preamble signature may be used to identify the UE 504 for scheduling communications (e.g., MSG2 and MSG3) with the network entity 502. The term “RACH preamble” may refer to or correspond to “random access preamble,” “preamble,” “preamble sequence,” and/or “preamble signature.”

At 512, the network entity 502 responds with a random access response (RAR) message (MSG2). For example, in certain aspects, at 511, the network entity 502 may send a PDCCH communication including DCI that schedules the RAR on the PDSCH. The RAR message and the DCI that schedule the RAR are examples of a RAR-related message. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble signature and indicate that the RAR is for the UE 504 that transmitted MSG1 at 510. As an example, the RAPID may identify a particular frequency resource used for the preamble transmission. The backoff parameter value may be used to determine a RACH occasion (RO) for sending a subsequent RACH transmission (e.g., a preamble transmission). An RO may correspond to one or more time-frequency resources available for transmitting a preamble on a RACH.

At 514, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (e.g., for an UL transmission). As an example, MSG3 may use the time-frequency resource(s) indicated in the UL grant of the RAR. In some examples, MSG3 may include a bitmap of one or more requested SI messages.

At 516, the network entity 502 sends a contention resolution message (MSG4) in response to MSG3. In some cases, if the UE 504 is unable to receive or decode MSG3 and/or MSG4, the UE 504 may repeat RACH procedure 500a.

After receiving MSG4 at 516, UE 504 monitors for other system information (OSI) (e.g., SIBs other than SIB1). Based on the monitoring, UE 504 may receive, at 518, SI message(s) (e.g., requested SI message(s)).

In some cases, to reduce the latency associated with random access, another RACH procedure may be used, such as a two-step RACH procedure instead of a four-step RACH procedure (e.g., RACH procedure 500a). As the name implies, the two-step RACH procedure may effectively consolidate the four messages of the four-step RACH procedure into two messages.

FIG. 5B depicts a process flow diagram of another example RACH procedure 500b (referred to as a “two-step RACH procedure”) performed between the UE 504 and the network entity 502. The RACH procedure 500b may optionally begin at 550, where the network entity 502 broadcasts and the UE 504 receives a MIB, for example within an SSB. Further, at 552, the network entity 502 broadcasts and the UE 504 receives a SIB1 (e.g., steps 550 and 552 in the RACH procedure 500b may be similar to steps 506 and 508 in the RACH procedure 500a). The SIB1 may include random access resources in SI-RequestConfig, where the RA resources are linked to requested SI messages.

At 554, the UE 504 sends a first message (MSG1 or MSGA) to the network entity 502, which may effectively combine MSG1 and MSG3 described above with respect to FIG. 5A. In some aspects, MSG1/MSGA includes a RACH preamble for random access and a payload. For example, the payload may include a UE-ID and other signaling information, such as a buffer status report and/or a scheduling request. The RACH preamble of MSG1/MSGA may be transmitted over the RACH, and the payload of MSGA may be transmitted over the PUSCH, for example.

At 556, the network entity 502 sends a random access response message (MSG2 or MSGB), which may effectively combine MSG2 and MSG4 described above with respect to FIG. 5A. For example, MSGB may include a RAPID. For example, in certain aspects, at 555, the network entity 502 may send a PDCCH communication including DCI that schedules the RAR on the PDSCH. The RAR message and the DCI that schedule the RAR are examples of a RAR-related message.

After receiving MSG2/MSGB, UE 504 monitors for OSI. Based on the monitoring, UE 504 may receive, at 558, SI message(s) (e.g., requested SI message(s)).

### Aspects Related to RACH Configuration Adaptation During a RACH Procedure

Aspects of the present disclosure provide techniques for RACH configuration adaptation during a RACH procedure. For example, the adaptation may occur during a RACH procedure to adjust RO(s) available for communicating a subsequent random access signal (e.g., to initiate another RACH procedure). For example, a UE may obtain a RACH configuration identifying first ROs corresponding to time-frequency resources configured for random access communications. An example first RACH procedure may begin with the UE sending, to a network entity, a first random access signal in a first RO associated with the RACH configuration. Upon successful reception, the network entity may send, to the UE, a random access response-related message to the random access signal. In certain aspects, a random access response-related message, such as the random access response or a DCI scheduling the random access response, may include a RACH configuration adaptation indication of an activation of an adaptation associated with one or more second ROs. The UE may adapt the RACH configuration based on the adaptation (e.g., associated with the one or more second ROs) such that RO(s) available for communicating a subsequent random access signal are adjusted. The UE may use the adapted RACH configuration, associated with the adjusted RO(s), to send a subsequent random access signal. The subsequent random access signal may be a re-transmission of the first random access signal or a transmission of a second random access signal to initiate a second RACH procedure.

In certain aspects, the adaptation, which the RACH configuration adaptation indication indicates is activated, is associated with at least one first RO associated with the RACH configuration (e.g., the first RO(s) associated with the RACH configuration include at least one second RO associated with the adaptation). In such cases, the adaptation may indicate to deactivate (or mute) the at least one second RO, such that the RO(s) available for communicating the subsequent random access signal are reduced. As an illustrative example, a RACH configuration may identify ten ROs (e.g., RO₁ through RO₁₀) corresponding to time-frequency resources configured for random access communications (e.g., associated with a first periodicity of 40 milliseconds (ms), indicating that one RO of the ten ROs may occur every 20 ms). An adaptation associated with five of the ten ROs (e.g., RO₂, RO₄, RO₆, RO₈, and RO₁₀) may be activated via a RACH configuration adaptation indication received prior in time to RO₁. The adaptation may indicate to deactivate (or mute) the five ROs. Thus, when adapting the RACH configuration (e.g., by adjusting the ROs), RO₂, RO₄, RO₆, RO₈, and RO₁₀ may be deactivated, thereby reducing the frequency for sending a subsequent random access signal. For example, the adjusted ROs may be associated with a second periodicity of 80 ms, indicating that one RO may occur every 80 ms.

In certain aspects, the adaptation, which the RACH configuration adaptation indication indicates is activated, is not associated with any of the first RO(s) associated with the first configuration (e.g., the first RO(s) associated with the RACH configuration do not include any second RO(s) associated with the adaptation). In such cases, the adaptation may indicate to activate (or add) the second RO(s), such that the RO(s) available for communicating the subsequent random access signal are increased. As an illustrative example, a RACH configuration may identify five ROs (e.g., RO₁, RO₂, RO₃, RO₄, and RO₅) corresponding to time-frequency resources configured for random access communications (e.g., associated with a first periodicity of 40 milliseconds (ms)). An adaptation associated with five additional ROs (e.g., RO_{1.5}, RO_{2.5}, RO_{3.5}, RO_{4.5}, and RO_{5.5}) may be activated via a RACH configuration adaptation indication received prior in time to RO₁. The adaptation may indicate to activate (or add) the five additional ROs. Thus, when adapting the RACH configuration (e.g., by adjusting the ROs), RO_{1.5}, RO_{2.5}, RO_{3.5}, RO_{4.5}, and RO_{5.5} may be activated, thereby increasing the frequency for sending a subsequent random access signal. For example, the adjusted ROs may be associated with a second periodicity of 20 ms, indicating that one RO may occur every 20 ms.

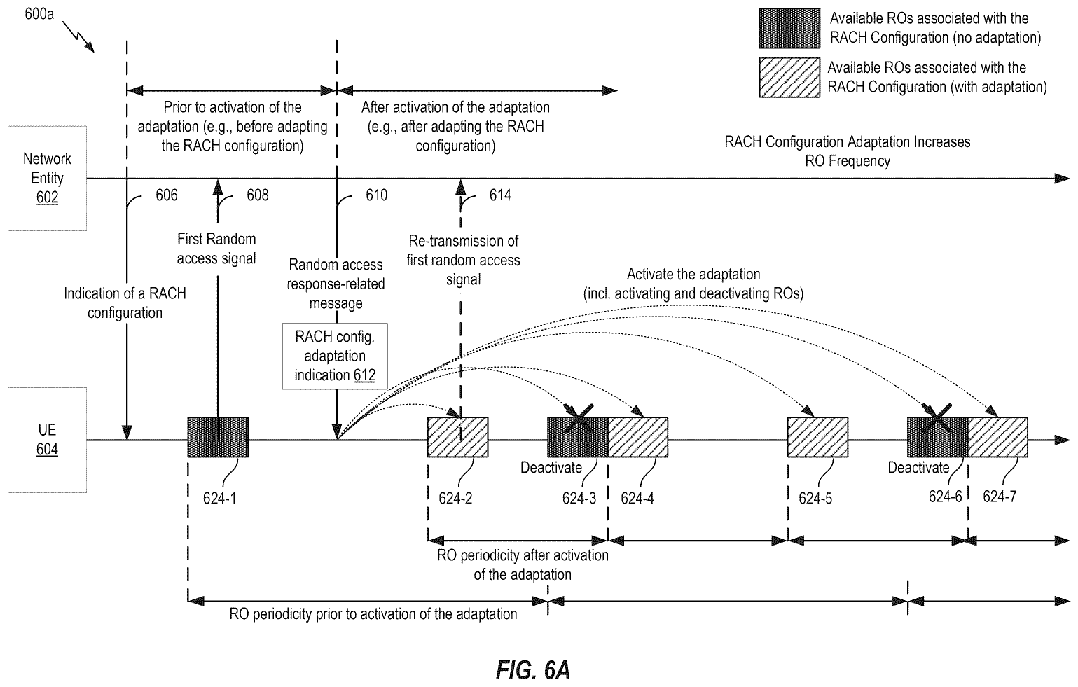

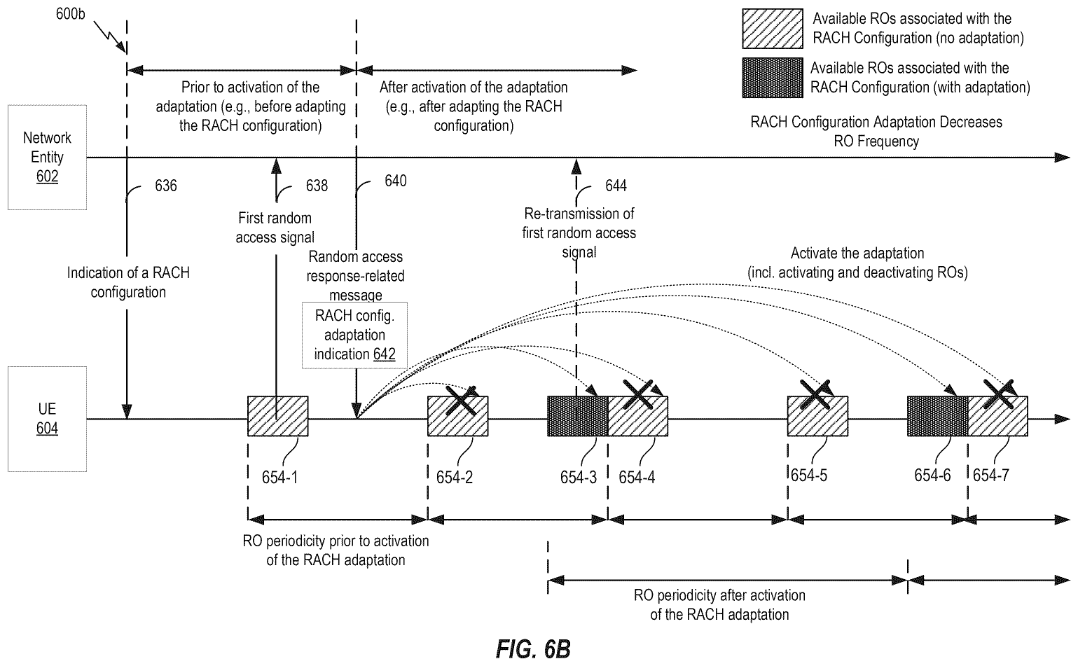

In certain aspects, the adaptation, indicated via the RACH configuration adaptation indication, is associated with all of the first RO(s) associated with the RACH configuration and one or more additional RO(s) (e.g., the second RO(s) associated with the adaptation include all of the first RO(s) associated with the RACH configuration plus one or more additional RO(s)). In such cases, the adaptation may indicate to both deactivate a first subset of the second RO(s) and activate a second subset of the RO(s) associated with the adaptation. For example, the adaptation may indicate to deactivate the first RO(s) associated with the RACH configuration, and activate one or more additional ROs. Put differently, the adaptation may indicate to deactivate the original RACH configuration in place of a new RACH configuration (e.g., associated with the additional RO(s)). In certain aspects, the new RACH configuration may have an RO periodicity greater than an RO periodicity of the original RACH configuration, such that the frequency for sending a subsequent random access signal is reduced. In certain aspects, the new RACH configuration may have an RO periodicity less than an RO periodicity of the original RACH configuration, such that the frequency for sending a subsequent random access signal is increased. In certain aspects, the new RACH configuration may have an RO periodicity equal to an RO periodicity of the original RACH configuration (although each RACH configuration is associated with different respective ROs). FIGS. 6A-6B depict example RACH configuration adaptation where ROs are both deactivated and activated based on the communication of a RACH configuration adaptation indication via a random access response-related message (e.g., during a RACH procedure).

### Example Signaling for Rach Configuration Adaptation During a Rach Procedure

FIGS. 6A-6B depict process flows 600a, 600b, respectively, for communications in a network between a network entity 602 and a UE 604. In certain aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

Signaling in process flow 600a of FIG. 6A or in process flow 600b of FIG. 6B may be performed to adapt a RACH configuration identifying ROs corresponding to time-frequency resources configured for random access communications. In certain aspects, as shown in both process flows 600a, 600b of FIGS. 6A and 6B, respectively, the RACH configuration may be adapted such as to activate new ROs and deactivate ROs associated with an original RACH configuration. In process flow 600a of FIG. 6A, the RACH configuration adaptation may occur to increase a frequency of ROs configured for random access communications, such as for communicating a subsequent random access signal after a RACH procedure has been initiated. Alternatively, in process flow 600b of FIG. 6B, the RACH configuration adaptation may occur to reduce a frequency of ROs configured for random access communications, such as for communicating the subsequent random access signal after a RACH procedure has been initiated.

Beginning with process flow 600a of FIG. 6A, at 606, network entity 602 sends, to UE 604, an indication of a RACH configuration. The RACH configuration may identify three ROs (e.g., RO 624-1, RO 624-3, and RO 624-6) corresponding to time-frequency resources configured for random access communications. For example, the RACH configuration may be associated with RO 624-1, RO 624-3, and RO 624-6, which have a first RO periodicity (e.g., shown as the RO periodicity prior to activation of the adaptation in FIG. 6A). UE 604 may use RO 624-1, RO 624-3, and/or RO 624-6 for sending a random access signal to initiate a RACH procedure with network entity 602.

At 608, UE 604 determines to initiate a first RACH procedure with network entity 602 and sends, to network entity 602, a first random access signal. In certain aspects, the first random access signal is a first message (MSG1) sent on a PRACH during a four-step RACH procedure, such as the first message (MSG1) sent at 510 in RACH procedure 500a of FIG. 5A. In certain aspects, the first random access signal is a first message (MSGA) sent on a PRACH during a two-step RACH procedure, such as the first message (MSGA) sent at 554 in RACH procedure 500b of FIG. 5B. In this example, UE 604 sends, to network entity 602, the first random access in RO 624-1, which is an RO associated with the RACH configuration (e.g., received at 606).

At 610, network entity 602 sends, to UE 604, a random access response-related message corresponding to the first random access signal communicated at 608. The random access response-related message may include a RACH configuration adaptation indication 612.

In certain aspects, the random access response-related message including RACH configuration adaptation indication 612, communicated at 610, is a RAR message (MSG2) sent during a four-step RACH procedure, such as the RAR message (MSG2) sent at 512 in RACH procedure 500a of FIG. 5A. In certain aspects, the random access response-related message including RACH configuration adaptation indication 612, communicated at 610, comprises DCI scheduling a RAR message (MSG2) sent during a four-step RACH procedure, such as the DCI sent at 511 in RACH procedure 500a of FIG. 5A. In certain aspects, the RACH configuration adaptation indication 612 is specified by one or more bits of a payload of the RAR message (e.g., bit(s) of the MSG2 payload).

In certain aspects, the random access response-related message including RACH configuration adaptation indication 612, communicated at 610, is a RAR message (MSGB) sent during a two-step RACH procedure, such as the RAR message (MSGB) sent at 556 in RACH procedure 500b of FIG. 5B. In certain aspects, the random access response-related message including RACH configuration adaptation indication 612, communicated at 610, comprises DCI scheduling a RAR message (MSGB) sent during a two-step RACH procedure, such as the DCI sent at 555 in RACH procedure 500b of FIG. 5B. In certain aspects, the RACH configuration adaptation indication 612 is specified by one or more bits of a payload of the RAR message (e.g., bit(s) of the MSGB payload).

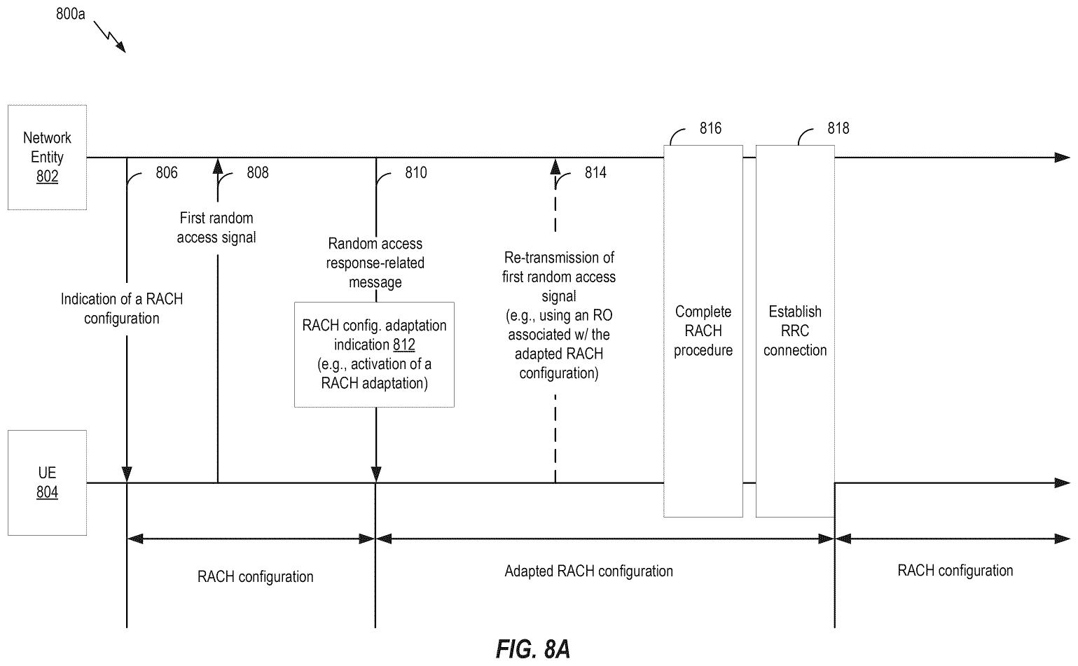

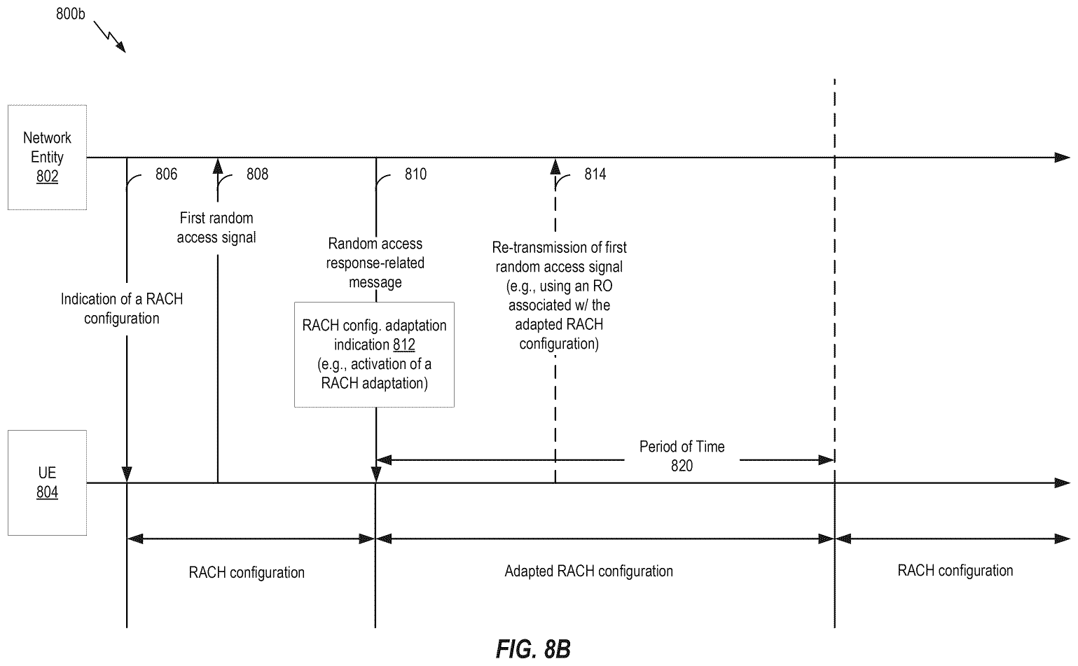

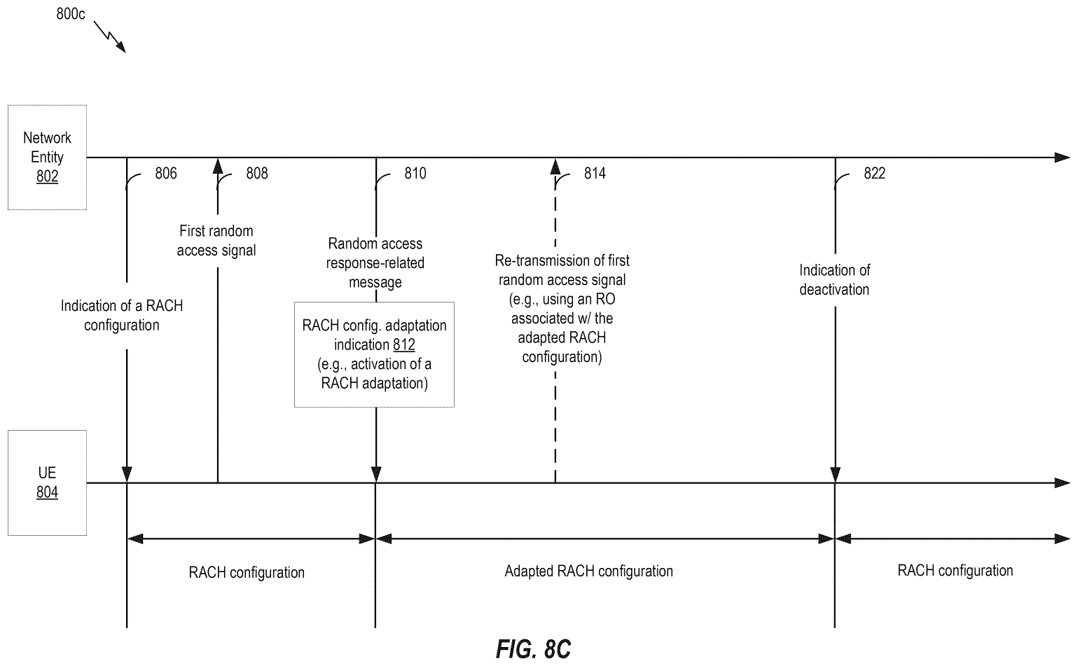

The RACH configuration adaptation indication 612 may be an indication of an activation of an adaptation associated with one or more RO(s). For this example, the RACH configuration adaptation indication 612 may be an indication of an activation of an adaptation associated with six ROs, e.g., RO 624-2, RO 624-3, RO 624-4, RO 624-5, RO 624-6, and RO 624-7. Two of the ROs associated with the adaptation (e.g., indicated to be activated by the RACH configuration adaptation indication 612), such as RO 624-3 and RO 624-6, are also associated with the RACH configuration (e.g., the original RACH configuration indicated to UE 604 at 606). In this example, the adaptation may (1) activate RO 624-2, RO 624-4, RO 624-5, and RO 624-7, while also (2) deactivating RO 624-3 and RO 624-6 (as shown in FIG. 6A). Thus, when the adaptation is activated (and where the RACH configuration adaptation indication 612 indicates such activation), RO 624-2, RO 624-4, RO 624-5, and RO 624-7 may be activated (e.g., added to the RACH configuration for subsequent random access communications, such as within a limited period of time as described below with respect to FIGS. 8A-8C). Further, when the adaptation is activated (and where the RACH configuration adaptation indication 612 indicates such activation), RO 624-3 and RO 624-6 may be deactivated (e.g., muted in the RACH configuration, where they are unable to be used for subsequent random access communications, such as within a limited period of time as described below with respect to FIGS. 8A-8C). Put differently, in this example, the original RACH configuration (e.g., indicated to UE 604 at 606), associated with RO 624-1, RO 624-3, and RO 624-6, may be replaced by a new RACH configuration (e.g., the adapted RACH configuration), associated with RO 624-2, RO 624-4, RO 624-5, and RO 624-7. ROs of the new RACH configuration may have a second RO periodicity (e.g., shown as the RO periodicity after to activation of the adaptation in FIG. 6A). The second RO periodicity may be less than the first RO periodicity associated with the original RACH configuration, such that the RACH configuration adaptation indication 612 increases the RO frequency.

This increase in RO frequency may enable the UE to send a re-transmission of the first random access signal or a second random access signal to initiate a second RACH procedure more frequently with the adapted (e.g., new) RACH configuration than with the original RACH configuration. For example, UE 604 may send, to network entity 602 at 614, a re-transmission of the first random access signal using an RO associated with the adapted RACH configuration. Specifically, in the example shown in FIG. 6A, UE 604 may use RO 624-2, associated with the adapted (e.g., new) RACH configuration to send a re-transmission of the first random access signal. Alternatively, in certain aspects, UE 604 may send, to network entity 602 at 614, a second random access signal to initiate a second RACH procedure using one of the RO(s) associated with the adapted (e.g., new) RACH configuration (not shown in FIG. 6A).

While, in FIG. 6A, the activation of the adaptation (e.g., based on network entity 602 sending, at 610, the random access response-related message including the RACH configuration adaptation indication 612 of activation of the adaptation) results in an increase in the RO frequency, in some other examples, an activation of an adaptation may result in a reduction in the RO frequency (e.g., reduction in the frequency of ROs that UE 604 may use during a period of time for sending a random access signal). This scenario is illustrated in FIG. 6B.

For example, in process flow 600b of FIG. 6B, the RACH configuration adaptation may occur to reduce a frequency of ROs configured for random access communications, such as for communicating the subsequent random access signal after a RACH procedure has been initiated.

Process flow 600b begins, at 636, with network entity 602 sending, to UE 604, an indication of a RACH configuration. The RACH configuration may identify five ROs (e.g., RO 654-1, RO 654-2, RO 654-4, RO 654-5, and RO 654-7) corresponding to time-frequency resources configured for random access communications. For example, the RACH configuration may be associated with RO 654-1, RO 654-2, RO 654-4, RO 654-5, and RO 654-7, which have a first RO periodicity (e.g., shown as the RO periodicity prior to activation of the adaptation in FIG. 6B). UE 604 may use RO 654-1, RO 654-2, RO 654-4, RO 654-5, and/or RO 654-7 for sending a random access signal to initiate a RACH procedure with network entity 602.

At 638, UE 604 determines to initiate a first RACH procedure with network entity 602 and sends, to network entity 602, a first random access signal. In certain aspects, the first random access signal is a first message (MSG1) sent on a PRACH during a four-step RACH procedure, such as the first message (MSG1) sent at 510 in RACH procedure 500a of FIG. 5A. In certain aspects, the first random access signal is a first message (MSGA) sent on a PRACH during a two-step RACH procedure, such as the first message (MSGA) sent at 554 in RACH procedure 500b of FIG. 5B. In this example, UE 604 sends, to network entity 602, the first random access in RO 654-1, which is an RO associated with the RACH configuration (e.g., received at 636).

At 640, network entity 602 sends, to UE 604, a random access response-related message corresponding to the first random access signal communicated at 638. The random access response-related message may include a RACH configuration adaptation indication 642.

The RACH configuration adaptation indication 642 may be an indication of an activation of an adaptation associated with one or more RO(s). For this example, the RACH configuration adaptation indication 642 may be an indication of an activation of an adaptation associated with six ROs, e.g., RO 654-2, RO 654-3, RO 654-4, RO 654-5, RO 654-6, and RO 654-7. Four of the ROs associated with the adaptation (e.g., indicated to be activated by the RACH configuration adaptation indication 642), such as RO 654-2, RO 654-4, RO 654-5, and RO 654-7, are also associated with the RACH configuration (e.g., the original RACH configuration indicated to UE 604 at 636). In this example, the adaptation may (1) activate RO 654-3 and RO 654-6, while also (2) deactivating RO 654-2, RO 654-4, RO 654-5, and RO 654-7 (as shown in FIG. 6B). Thus, when the adaptation is activated (and where the RACH configuration adaptation indication 642 indicates such activation), RO 654-3 and RO 654-6 may be activated (e.g., added to the RACH configuration for subsequent random access communications, such as within a limited period of time as described below with respect to FIGS. 8A-8C). Further, when the adaptation is activated (and where the RACH configuration adaptation indication 612 indicates such activation), RO 654-2, RO 654-4, RO 654-5, and RO 654-7 may be deactivated (e.g., muted in the RACH configuration, where they are unable to be used for subsequent random access communications, such as within a limited period of time as described below with respect to FIGS. 8A-8C). Put differently, in this example, the original RACH configuration (e.g., indicated to UE 604 at 636), associated with RO 654-1, RO 654-2, RO 654-4, RO 654-5, and RO 654-7, may be replaced by a new RACH configuration (e.g., the adapted RACH configuration), associated with RO 654-3 and RO 654-6. ROs of the new RACH configuration may have a second RO periodicity (e.g., shown as the RO periodicity after to activation of the adaptation in FIG. 6B). The second RO periodicity may be greater than the first RO periodicity associated with the original RACH configuration, such that the RACH configuration adaptation indication 612 reduces the RO frequency.

UE 604 may use the adapted (e.g., new) RACH configuration to send a subsequent random access signal to network entity 602. For example, UE 604 may send, to network entity 602 at 644, a re-transmission of the first random access signal using an RO associated with the adapted RACH configuration. Specifically, in the example shown in FIG. 6B, UE 604 may use RO 654-3, associated with the adapted (e.g., new) RACH configuration to send a re-transmission of the first random access signal. Alternatively, in certain aspects, UE 604 may send, to network entity 602 at 644, a second random access signal to initiate a second RACH procedure using one of the RO(s) associated with the adapted (e.g., new) RACH configuration (not shown in FIG. 6B).

Although FIGS. 6A and 6B depict the example use of a RACH configuration adaptation indication to change RO periodicity, in some other examples, a RACH configuration adaptation indication may be used to more generally cause any change to the configured ROs, such as including adding (e.g., activating) one or more ROs and/or muting one or more ROs (e.g., deactivating).

In certain aspects (although not shown in FIGS. 6A and 6B), UE 604 may receive an indication of a plurality of indexes associated with a plurality of adaptations prior to receiving the random access response-related message at 610 in FIG. 6A or at 640 in FIG. 6B. In certain aspects, UE 604 receives the indication of the plurality of indexes in one or more system information (SI) messages. In certain aspects, UE 604 receives the indication of the plurality of indexes via RRC signaling (e.g., an RRC configuration).

Each index, in the plurality of indexes received at UE 604, may be associated with an adaptation for a respective set (e.g., one or more) of ROs. For example, a first index may be associated with a first adaptation and a second index may be associated with a second adaptation. The first adaptation may be associated with four ROs, and may be used to deactivate and/or activate each of the four ROs when activated. The second adaptation may be associated with six different ROs, and may be used to deactivate and/or activate each of the six ROs when activated. In certain aspects, the RACH configuration adaptation indication 612, 642 (e.g., included in the random access response-related message sent by network entity 602 at 610, 640) may comprise an indication of one of the indexes sent to UE 604, such as the first index. Based on receiving the RACH configuration adaptation indication 612, 642, or more specifically the first index, UE 604 may determine that the first adaptation is associated with the first index, and accordingly adapt the RACH configuration according to the first adaptation. Put differently, sending the plurality of indexes to the UE 604 prior to when an adaptation is needed (e.g., to activate and/or deactivate RO(s)), may allow for an adaptation to be indicated to the UE 604 via an index. Indicating the index to the UE 604, via the random access response-related message, may activate an adaptation, such that the RACH configuration is adapted to a pre-indicated configuration. Less bits may be used to send the random access response-related message with the index than when sending the random access response-related message with an adaptation for a detailed RACH configuration, thereby reducing transmission overhead for RACH configuration adaptation.

Note that the process flows 600a, 600b illustrated in FIGS. 6A, 6B, respectively, are described herein to facilitate an understanding of RACH configuration adaptation, and aspects of the present disclosure may be performed in various manners via alternative or additional signaling and/or operations. In certain aspects, the operations and/or signaling of FIG. 6 may occur in an order different from that described or depicted, and various actions, operations, and/or signaling may be added, omitted, or combined.

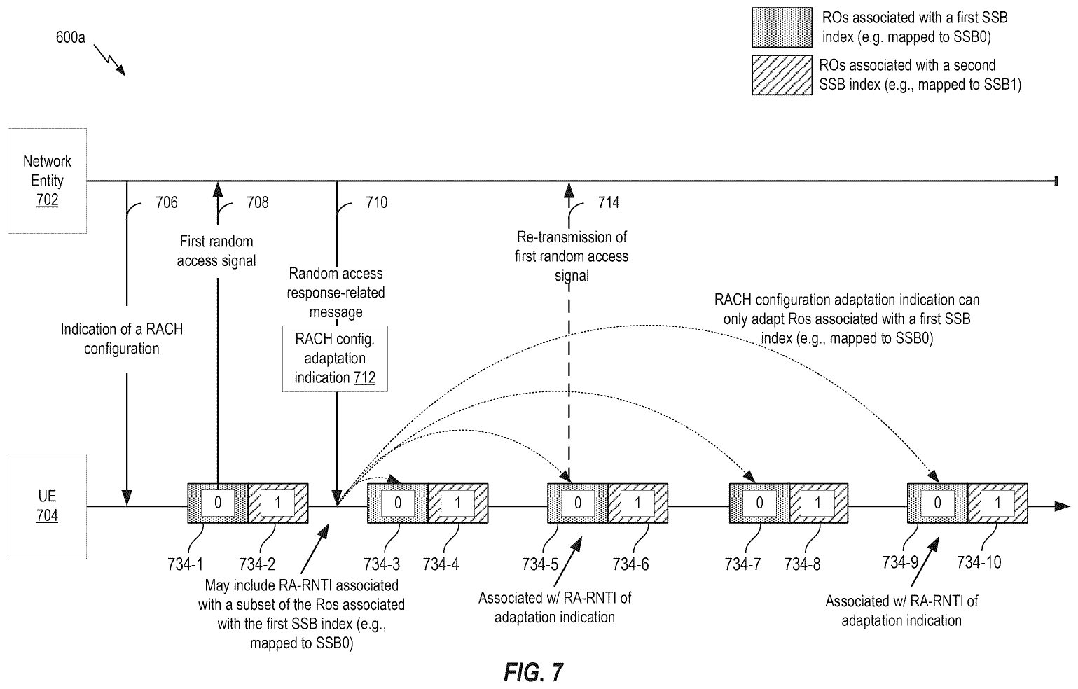

In certain aspects, the ROs associated with an adaptation, or more specifically the ROs that may be adapted via a RACH configuration adaptation indication (e.g., sent via a random access response-related message), may be limited. For example, in certain aspects, a RACH configuration adaptation indication of an activation of an adaptation may be used to adapt only ROs associated with a particular synchronization signal block (SSB) index. Adapting a set of RO(s) associated with a specific SSB index, to adapt a RACH configuration for random access communications, is illustrated in FIG. 7.

FIG. 7 depicts a process flow 700 for communications in a network between a network entity 702 and a UE 704. In certain aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

Process flow 700 begins, at 706, with network entity 702 sending, to UE 704, an indication of a RACH configuration associated with one or more first ROs.

At 708, UE 704 determines to initiate a first RACH procedure with network entity 702 and sends, to network entity 702, a first random access signal. In certain aspects, the first random access signal is a first message (MSG1) sent on a PRACH during a four-step RACH procedure, such as the first message (MSG1) sent at 510 in RACH procedure 500a of FIG. 5A. In certain aspects, the first random access signal is a first message (MSGA) sent on a PRACH during a two-step RACH procedure, such as the first message (MSGA) sent at 554 in RACH procedure 500b of FIG. 5B. In certain aspects, UE 704 sends, to network entity 702, the first random access signal in a first RO of the first RO(s) associated with the RACH configuration.

At 710, network entity 702 sends, to UE 704, a random access response-related message corresponding to the first random access signal communicated at 708. The random access response-related message may include a RACH configuration adaptation indication 712. The RACH configuration adaptation may be an indication of an activation of an adaptation associated with one or more RO(s).

It is noted that the steps 706-710 of process flow 700 of FIG. 7 are similar to steps 606-610 depicted and described with respect to FIG. 6A and steps 636-644 depicted and described with respect to FIG. 6B.

In certain aspects, different sets of ROs (e.g., one or more ROs) configured for random access communications may be mapped to different SSB indexes. In particular, a first set of ROs may be mapped to and associated with, a first SSB index, a second set of ROs may be mapped to and associated with, a second SSB index, and so on. For example, as shown in FIG. 7, ten ROs, RO 734-1 through 734-10, may be associated with a first SSB index (e.g., SSB0) and a second SSB index (e.g., SSB1). Specifically, RO 734-1, RO 734-3, RO 734-5, RO 734-7, and RO 734-9 are associated with the first SSB index (e.g., SSB0). Further, RO 734-2, RO 734-4, RO 734-6, RO 734-8, and RO 734-10 are associated with the second SSB index (e.g., SSB1).

In certain aspects, where ROs are mapped to multiple SSB indexes, then an adaptation may be associated with, and apply to, ROs associated with a particular SSB index. For example, in certain aspects, an adaptation indicated to be activated by a RACH configuration adaptation indication may be associated with, or applied to, only RO(s) associated with a same SSB index as an SSB index associated with an RO occasion where a random access signal was previously transmitted (e.g., triggering the transmission of the random access response-related message carrying the RACH configuration adaptation indication).

For example, in FIG. 7, UE 704 sends, to network entity 702 at 708, the first random access signal in an RO 734-1 associated with SSB0. Thus, the adaptation indicated to be activated by RACH configuration adaptation indication 712 may only be associated with, or only apply to, other ROs also associated with SSB0, such as RO 734-3, RO 734-5, RO 734-7, and RO 734-9. Put differently, for each of RO 734-3, RO 734-5, RO 734-7, and RO 734-9, the adaptation may activate or deactivate each respective RO. However, the adaptation may not activate and/or deactivate any of the ROs associated with SSB1 (e.g., RO 734-2, RO 734-4, RO 734-6, RO 734-8, and RO 734-10).

In certain aspects, adaptation of the RACH configuration based on the adaptation adapts all ROs (e.g., occurring later in time than when the random access response-related message including the RACH configuration adaptation indication 712 is received) associated with a same SSB index as the SSB index of the RO where the first random access signal was sent. Adapting all ROs associated with the same SSB index as the SSB index of the RO where the first random access signal was sent, includes activating or deactivating all of the ROs for random access communications. For example, in FIG. 7, adaptation of the RACH configuration based on the adaptation adapts (e.g., activates or deactivates) all of RO 734-3, RO 734-5, RO 734-7, and RO 734-9, associated with SSB0.

In certain aspects, adaptation of the RACH configuration based on the adaptation adapts a subset of ROs (e.g., less than all ROs) (e.g. occurring later in time than when the random access response-related message including the RACH configuration adaptation indication 712 is received) associated with a same SSB index as the SSB index of the RO where the first random access signal was sent. For example, in certain aspects, RACH configuration adaptation indication 712 may include a random access radio network temporary identify (RA-RNTI). This RA-RNTI included in RACH configuration adaptation indication 712 may be associated with a subset of ROs associated with a same SSB index as the SSB index of the RO where the first random access signal was sent. Thus, based on the RA-RNTI included in the RACH configuration adaptation indication 712, UE 704 may determine which RO(s) the adaptation applies to (e.g., such this subset of RO(s) may be activated or deactivated). For example, in FIG. 7, RACH configuration adaption indication 712 may include a RA-RNTI associated with two of the ROs associated with SSB0, namely RO 734-5 and RO 734-9. Thus, only these two ROs may be adapted based on receiving the RACH configuration adaptation indication 712.

In FIG. 7, UE 704 adapts the RACH configuration (e.g., indicated to UE 704 at 706) based on the RACH configuration adaptation indication 712 and based on an SSB index of RO 734-1 where the first random access signal is sent. In this example, adapting the RACH configuration may include activating at least RO 734-5 and RO 734-9. Using the adapted RACH configuration, UE 704 may send, to network entity 702 at 714, a re-transmission of the first random access signal using RO 734-5 associated with the adapted RACH configuration (or RO 734-9 may be used, although not shown). Alternatively, in certain aspects, UE 704 may send, to network entity 702 at 714, a second random access signal to initiate a second RACH procedure using RO 734-5 associated with the adapted RACH configuration (or RO 734-9 may be used, although neither of these cases are shown in FIG. 7).

Note that the process flow 700 illustrated in FIG. 7 is described herein to facilitate an understanding of RACH configuration adaptation, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

In certain aspects, an adaptation associated with one or more ROs, indicated via a RACH configuration adaptation indication, may be activated for a limited period of time. That is, a UE receiving the RACH configuration adaptation indication may assume that the adaptation is valid until one or more conditions are met. For example, in certain aspects, the UE may assume the adaptation is valid, and therefore use an adapted RACH configuration for random access communications, until the UE successfully completes and RACH procedure to establish an RRC connection with a network entity (e.g., the adaptation is valid from when the RACH configuration adaptation indication is received until the UE establishes an RRC connection, or contention resolution is resolved). After the UE establishes the RRC connection with the network entity, the UE may no longer use the adapted RACH configuration for RACH communications. This condition is depicted and described below with respect to FIG. 8A.

In certain aspects, the UE may assume the adaptation is valid, and therefore use an adapted RACH configuration for random access communications, only for a period of time after reception of the random access response-related message comprising the RACH configuration adaptation indication. Put differently, the UE may adapt the RACH configuration after receiving the random access response-related message and use the adapted RACH configuration for only a limited period of time defined, which may be defined by a time, a number of frames, a number of slots, and/or a number of symbols. After the period of time has expired, the UE may no longer use the adapted RACH configuration for RACH communications. This condition is depicted and described below with respect to FIG. 8B.

In certain aspects, the UE may assume the adaptation is valid, and therefore use an adapted RACH configuration for random access communications, until the UE receives an indication of deactivation of the adaptation. After receiving the indication of deactivation of the adaptation, the UE may no longer use the adapted RACH configuration for RACH communications. This condition is depicted and described below with respect to FIG. 8C.

FIGS. 8A-8C depict process flows 800a, 800b, 800c, respectively, for communications in a network between a network entity 802 and a UE 804. In certain aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

As described above, process flows 800a, 800b, 800c of FIGS. 8A-8C, respectively, depict the adaptation of a RACH configuration for a limited period of time, such as when one or more conditions are met.

Each of process flows 800a, 800b, 800c of FIGS. 8A-8C, respectively, begin, at 806, with network entity 802 sending, to UE 804, an indication of a RACH configuration associated with one or more firs ROs.

At 808, UE 804 determines to initiate a first RACH procedure with network entity 802 and sends, to network entity 802, a first random access signal. In certain aspects, the first random access signal is a first message (MSG1) sent on a PRACH during a four-step RACH procedure, such as the first message (MSG1) sent at 510 in RACH procedure 500a of FIG. 5A. In certain aspects, the first random access signal is a first message (MSGA) sent on a PRACH during a two-step RACH procedure, such as the first message (MSGA) sent at 554 in RACH procedure 500b of FIG. 5B. In certain aspects, UE 804 sends, to network entity 802, the first random access signal in a first RO of the first RO(s) associated with the RACH configuration.

At 810, network entity 802 sends, to UE 804, a random access response-related message corresponding to the first random access signal communicated at 808. The random access response-related message may include a RACH configuration adaptation indication 812. The RACH configuration adaptation may be an indication of an activation of an adaptation associated with one or more RO(s).

As shown in process flows 800a, 800b, 800c of FIGS. 8A-8C, UE 804 adapts the RACH configuration (e.g., indicated to UE 804 at 806) based on the RACH configuration adaptation indication 812. Thus, in certain aspects, UE 804 may send, to network entity 802 at 814, a re-transmission of the first random access signal using the RO(s) associated with the adapted RACH configuration. Alternatively, in certain aspects, UE 804 may send, to network entity 802 at 814, a second random access signal to initiate a second RACH procedure using the RO(s) associated with the adapted RACH configuration (not shown in FIGS. 8A-8C).

It is noted that the steps 806-810 of process flows 800a, 800b, 800c of FIGS. 8A-8C are similar to steps 606-610 depicted and described with respect to FIG. 6A, steps 636-644 depicted and described with respect to FIG. 6B, and steps 706-710 depicted and described with respect to FIG. 7.

In FIGS. 8A-8C, however, UE 804 may assume that the adapted RACH configuration is valid for only a limited period of time.

For example, in process flow 800a of FIG. 8A, UE 804 may assume that the adapted RACH configuration is valid from when the RACH configuration adaptation indication 812 is received (e.g., via the random access response-related message received at 810) until the UE 804 establishes an RRC connection with network entity 802, or contention resolution is resolved. As such, as shown in process flow 800a of FIG. 8A, UE 804 may complete a RACH procedure at 816 and establish an RRC connection with network entity 802 at the completion of the procedure. After 816, e.g., when the RRC connection is established, UE 804 may return to using the RACH configuration indicated, by network entity 802, to UE 804 at 806, instead of the adapted RACH configuration. That is, UE 804 may use the RO(s) associated with the RACH configuration, instead of the adapted RACH configuration, to send one or more subsequent random access signals.

In certain aspects, the RACH procedure completed at 816 is the first RACH procedure initiated by UE 804 sending the first random access signal at 808. In certain other aspects, the RACH procedure completed at 816 is the first RACH procedure initiated by UE 804 sending a re-transmission of the first random access signal at 814. In certain other aspects, the RACH procedure completed at 816 is another RACH procedure initiated by UE 804 sending another random access signal (not shown in FIGS. 8A-8C).

In process flow 800b of FIG. 8B, UE 804 may assume that the adapted RACH configuration is valid from when the RACH configuration adaptation indication 812 indication is received (e.g., via the random access response-related message received at 810) until a period of time 820 has passed. For example, at the expiration of the period of time 820 (e.g., starting from reception of the random access response-related message at 810), UE 804 may return to using the RACH configuration indicated, by network entity 802, to UE 804 at 806, instead of the adapted RACH configuration. That is, UE 804 may use the RO(s) associated with the RACH configuration, instead of the adapted RACH configuration, to send one or more subsequent random access signals. The period of time 820 may be may be defined by a time, a number of frames, a number of slots, and/or a number of symbols. In certain aspects, the period of time is defined in a wireless standards specification. In certain aspects, the period of time is indicated in the RACH configuration adaptation indication 812. In certain aspects, the period of time is provided as part of a configuration, such as an additional ROs configuration and/or the RACH configuration indicated at 806. The period of time may be defined in terms of symbols, slots, frames, etc.

In certain aspects, the adaptation of the RACH configuration increases RO frequency for random access communications (as compared to the RACH configuration indicated to UE 804 at 806). Thus, the adapted RACH configuration may help to reduce latency in UE 804 establishing an RRC connection with network entity 802 (e.g., such as by enabling UE 804 to send a random access signal, used to initiate a RACH procedure, more frequently). This increased RO frequency, however, may reduce power savings at UE 804. Thus, by assuming the adaptation is valid for only a limited period of time, latency in establishing an RRC connection may be reduced, however, while also considering power savings at UE 804.

In process flow 800c of FIG. 8C, UE 804 may assume that the adapted RACH configuration is valid from when the RACH configuration adaptation indication 812 indication is received (e.g., via the random access response-related message received at 610) until an indication of deactivation of the adaptation is received, at 822. For example, after the indication of deactivation of the adaption is received, at 822, UE 804 may use the RO(s) associated with the RACH configuration, instead of the adapted RACH configuration, to send one or more subsequent random access signals.

Note that each process flow 800a, 800b, 800c illustrated in FIGS. 8A-8C, respectively, is described herein to facilitate an understanding of RACH configuration adaptation, and aspects of the present disclosure may be performed in various manners via alternative or additional signaling and/or operations. In certain aspects, the operations and/or signaling of FIGS. 8A-8C may occur in an order different from that described or depicted, and various actions, operations, and/or signaling may be added, omitted, or combined.

### Example Operations of a User Equipment

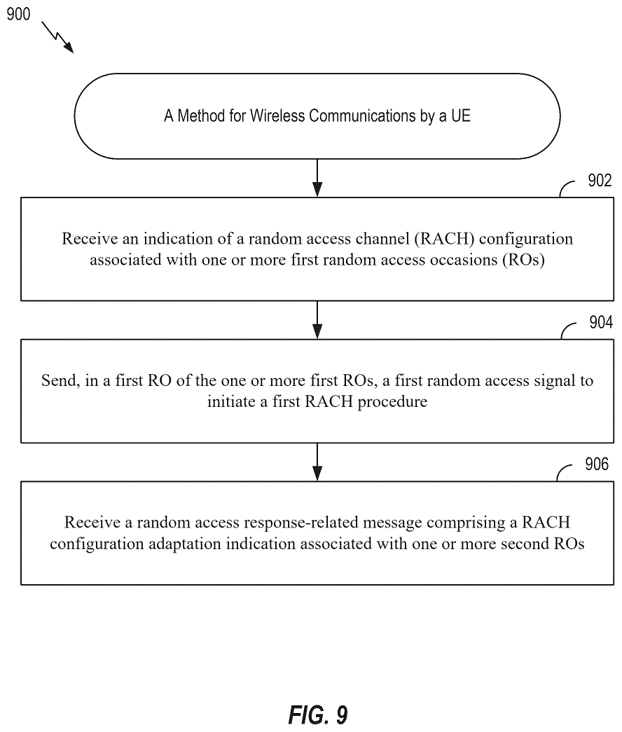

FIG. 9 shows a method 900 for wireless communications by a UE, such as UE 104 of FIG. 1 or UE 304 of FIG. 3.

Method 900 begins at block 902 with receiving an indication of a RACH configuration associated with one or more first ROs.

Method 900 then proceeds to block 904 with sending, in a first RO of the one or more first ROs, a first random access signal to initiate a first RACH procedure.

Method 900 then proceeds to block 906 with receiving a random access response-related message comprising a RACH configuration adaptation associated with one or more second ROs. In certain aspects, the RACH configuration adaptation activates an adaptation associated with the one or more second ROs.

In some aspects, method 900 further includes: adapting the RACH configuration based on the RACH configuration adaptation indication.

In some aspects, method 900 further includes, after reception of the random access response-related message, send in a second RO of the one or more second ROs: a re-transmission of the first random access signal to initiate a second RACH procedure; or a second random access signal to initiate a second RACH procedure.

In some aspects, method 900 further includes: receiving a contention resolution message; and establishing a radio resource control (RRC) connection with a network entity based on the reception of the contention resolution message, wherein adapting the RACH configuration comprises adapting the RACH configuration until the RRC connection is established with the network entity.

In some aspects, adapting the RACH configuration comprises adapting the RACH configuration only for a period of time after reception of the random access response-related message.

In some aspects, method 900 further includes receiving an indication of deactivation of an adaptation associated with the RACH configuration adaptation indication.

In some aspects, the one or more second ROs are different than the one or more first ROs.

In some aspects, the one or more first ROs comprise at least one of the one or more second ROs.

In some aspects, the one or more first ROs comprise all of the one or more second ROs.

In some aspects, the random access response-related message comprises a downlink control information comprising the RACH configuration adaptation indication.

In some aspects, the random access response-related message comprises a random access response comprising the RACH configuration adaptation indication.

In some aspects, the RACH configuration adaptation indication is specified by one or more bits of the random access response.

In some aspects, method 900 further includes: receiving an indication of a plurality of indexes associated with a plurality of adaptations, wherein: the plurality of indexes comprise at least a first index associated with an adaptation associated with the RACH configuration adaptation indication; and the respective index associated with each respective adaptation of the plurality of adaptations is associated with one or more respective ROs; and the RACH configuration adaptation indication comprises an indication of the first index.

In some aspects, receiving the indication of the plurality of indexes comprises receiving the indication of the plurality of indexes in one or more system information messages.

In some aspects, receiving the indication of the plurality of indexes comprises receiving the indication of the plurality of indexes via radio resource control (RRC) signaling.

In some aspects, the first random access signal is associated with a first synchronization signal block (SSB) index; and the one or more second ROs are associated with the first SSB index.

In some aspects, the one or more second ROs comprise a subset of a plurality of third ROs associated with the first SSB index.

In some aspects, the RACH configuration adaptation indication comprises a random access radio network temporary identity (RA-RNTI) associated with the one or more second ROs.

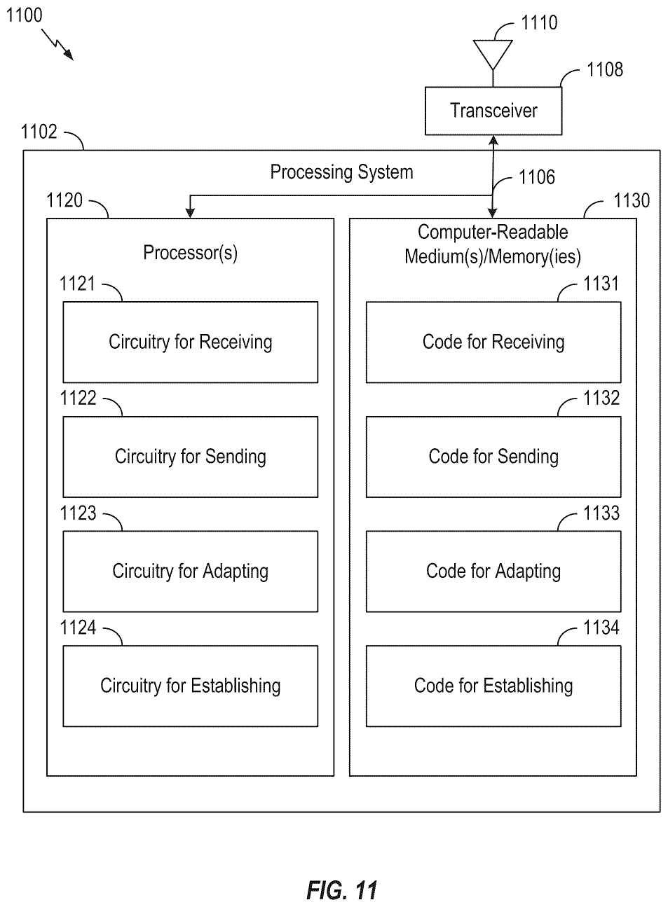

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

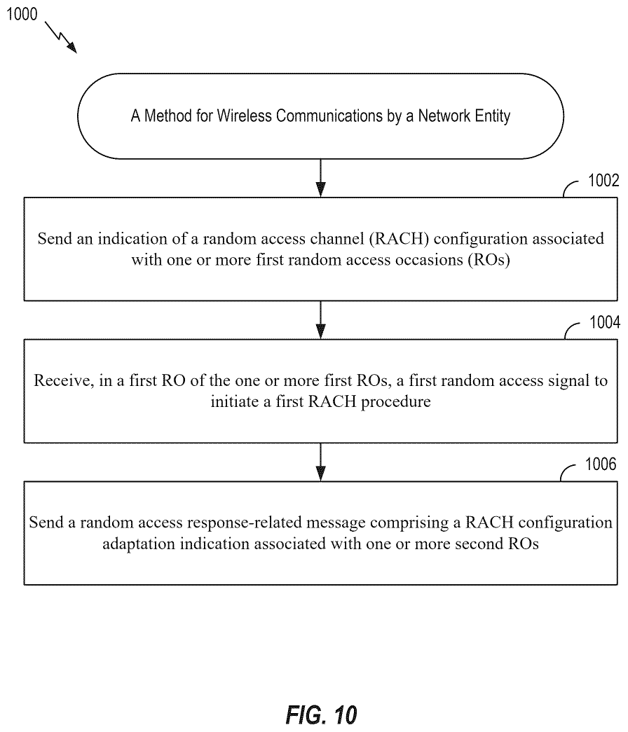

FIG. 10 shows a method 1000 for wireless communications by a network entity, such as BS 102 of FIG. 1, a first network entity 300 or second network entity 302 of FIG. 3, or a disaggregated base station as discussed with respect to FIG. 2.

Method 1000 begins at block 1002 with sending an indication of a RACH configuration associated with one or more first ROs.

Method 1000 then proceeds to block 1004 with receiving, in a first RO of the one or more first ROs, a first random access signal to initiate a first RACH procedure.

Method 1000 then proceeds to block 1006 with sending a random access response-related message comprising a RACH configuration adaptation indication associated with one or more second ROs. In certain aspects, transmission of the RACH configuration adaptation activates an adaptation associated with the one or more second ROs.

In some aspects, method 1000 further includes: adapting the RACH configuration based on the RACH configuration adaptation indication.

In some aspects, method 1000 further includes, after transmission of the random access response-related message, receiving in a second RO of the one or more second ROs: a re-transmission of the first random access signal to initiate a second RACH procedure; or a second random access signal to initiate a second RACH procedure.

In some aspects, method 1000 further includes: sending a contention resolution message; and establishing a radio resource control (RRC) connection with a user equipment based on the reception of the contention resolution message; and adapting the RACH configuration, comprises adapting the RACH configuration until the RRC connection is established with the user equipment.

In some aspects, adapting the RACH configuration comprises adapting the RACH configuration only for a period of time after transmission of the random access response-related message.

In some aspects, method 1000 further includes sending an indication of deactivation of an adaptation associated with the RACH configuration adaptation indication.

In some aspects, the one or more second ROs are different than the one or more first ROs.

In some aspects, the one or more first ROs comprise at least one of the one or more second ROs.

In some aspects, the one or more first ROs comprise all of the one or more second ROs.

In some aspects, the random access response-related message comprises a downlink control information comprising the RACH configuration adaptation indication.

In some aspects, the random access response-related message comprises a random access response comprising the RACH configuration adaptation indication.

In some aspects, the RACH configuration adaptation indication is specified by one or more bits of the random access response.

In some aspects, method 1000 further includes sending an indication of a plurality of indexes associated with a plurality of adaptations, wherein: the plurality of indexes comprise at least a first index associated with an adaptation associated with the RACH configuration adaptation indication; and the respective index associated with each respective adaptation of the plurality of adaptations is associated with one or more respective ROs; and the RACH configuration adaptation indication comprises an indication of the first index.

In some aspects, sending the indication of the plurality of indexes comprises sending the indication of the plurality of indexes in one or more system information messages.

In some aspects, sending the indication of the plurality of indexes comprises sending the indication of the plurality of indexes via radio resource control (RRC) signaling.

In some aspects, the first random access signal is associated with a first synchronization signal block (SSB) index; and the one or more second ROs are associated with the first SSB index.

In some aspects, the one or more second ROs comprise a subset of a plurality of third ROs associated with the first SSB index.

In some aspects, the RACH configuration adaptation indication comprises a random access radio network temporary identity (RA-RNTI) associated with the one or more second ROs.

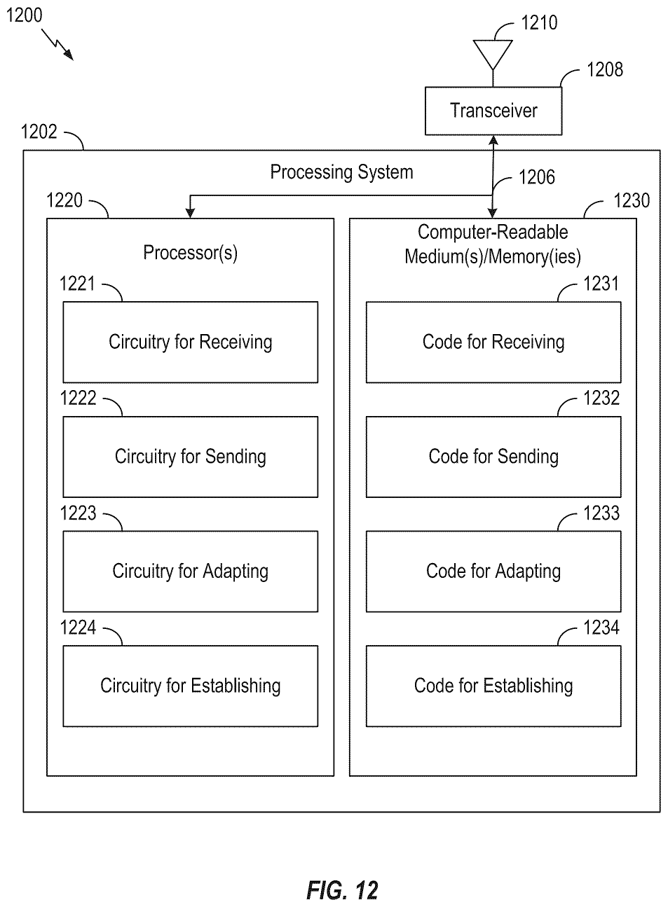

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120 and a computer-readable medium/memory 1130. In various aspects, the one or more processors 1120 may be representative of the one or more processors 318 described with respect to FIG. 3. The one or more processors 1120 are coupled to a computer-readable medium/memory 1130 via a bus 1106. In some aspects, the computer-readable medium/memory 1130 may be representative of the one or more memories 320 described with respect to FIG. 3. The computer-readable medium/memory 1130 is a non-transitory computer-readable medium/memory. In certain aspects, the computer-readable medium/memory 1130 is configured to store instructions (e.g., computer-executable code) that when executed by the one or more processors 1120, cause the one or more processors 1120 to perform the method 900 described with respect to FIG. 9, or any aspect related to the method 900, including any operations described in relation to FIGS. 6A, 6B, 7, 8A, 8B, and/or 8C. Note that reference to a processor performing a function of communications device 1100 may include one or more processors performing that function of communications device 1100, such as in a distributed fashion.

In the depicted example, computer-readable medium/memory 1130 stores code (e.g., executable instructions) for receiving 1131, code for sending 1132, code for adapting 1133, and code for establishing 1134. Processing of the code 1131-1134 may enable and cause the communications device 1100 to perform the method 900 described with respect to FIG. 9, or any aspect related to the method 900.

The one or more processors 1120 include circuitry configured to implement (e.g., execute) the code stored in the computer-readable medium/memory 1130, including circuitry for receiving 1121, circuitry for sending 1122, circuitry for adapting 1123, and circuitry for establishing 1124 may enable and cause the communications device 1100 to perform the method 900 described with respect to FIG. 9, or any aspect related to the method 900.

More generally, means for communicating, transmitting, sending or outputting for transmission may include the one or more transceivers 324, one or more antennas 322, and/or processing system 316 of the UE 304 illustrated in FIG. 3, transceiver 1108 and/or antenna 1110 of the communications device 1100 in FIG. 11, and/or one or more processors 1120 of the communications device 1100 in FIG. 11. Means for communicating, receiving or obtaining may include the one or more transceivers 324, one or more antennas 322, and/or processing system 316 of the UE 304 illustrated in FIG. 3, transceiver 1108 and/or antenna 1110 of the communications device 1100 in FIG. 11, and/or one or more processors 1120 of the communications device 1100 in FIG. 11.

FIG. 12 depicts aspects of an example communications device configured for wireless communications. In some aspects, communications device 1200 is a network entity, such as BS 102 of FIG. 1, first network entity 300 or second network entity 302 of FIG. 3, or a disaggregated base station as discussed with respect to FIG. 2.

The communications device 1200 includes a processing system 1202 coupled to a transceiver 1208 (e.g., a transmitter and/or a receiver) and/or a network interface 1212. The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 2. The processing system 1202 may be configured to perform processing functions for the communications device 1200, including processing signals received and/or to be transmitted by the communications device 1200.

The processing system 1202 includes one or more processors 1220 and a computer-readable medium/memory 1230. In various aspects, one or more processors 1220 may be representative of the one or more processors 308, as described with respect to FIG. 3. The one or more processors 1220 are coupled to the computer-readable medium/memory 1230 via a bus 1206. In certain aspects, the computer-readable medium/memory 1230 is configured to store instructions (e.g., computer-executable code), including code aspects 1231-1234, that when executed by the one or more processors 1220, cause the one or more processors 1220 to perform the method 1000 described with respect to FIG. 10, or any aspect related to method 1000, including any operations described in relation to FIGS. 6A, 6B, 7, 8A, 8B, and/or 8C. The computer-readable medium/memory 1230 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1230 stores code (e.g., executable instructions) for receiving 1231, code for sending 1232, code for adapting 1233, and code for establishing 1234. Processing of the code 1231-1234 may enable and cause the communications device 1200 to perform the method 1000 described with respect to FIG. 10, or any aspect related to it.

The one or more processors 1220 include circuitry configured to implement (e.g., execute) the code stored in the computer-readable medium/memory 1230, including circuitry for receiving 1221, circuitry for sending 1222, circuitry for adapting 1223, and circuitry for establishing 1224 may enable and cause the communications device 1200 to perform the method 1000 as described with respect to FIG. 10, or any aspect related to it.

Various components of the communications device 1200 may provide means for performing the method 1000 as described with respect to FIG. 10, or any aspect related to method 1000. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1208, antenna 1210, and/or network interface 1212 of the communications device 1200 in FIG. 12, and/or one or more processors 1220 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1208, antenna 1210, and/or network interface 1212 of the communications device 1200 in FIG. 12, and/or one or more processors 1220 of the communications device 1200 in FIG. 12. For example, means for adapting and/or means for establishing of the method 1000 described with respect to FIG. 10, or any aspect related to method 1000, may include one or more processors 1220 of the communications device 1200 in FIG. 12.

### Example Clauses

Implementation examples are described in the following numbered clauses:

Clause 1: A method, comprising: receiving an indication of a random access channel (RACH) configuration associated with one or more first RACH occasions (ROs); sending, in a first RO of the one or more first ROs, a first random access signal to initiate a first RACH procedure; and receiving a random access response-related message comprising a RACH configuration adaptation indication associated with one or more second ROs.

Clause 2: The method of Clause 1, further comprising: adapting the RACH configuration based on the RACH configuration adaptation indication.

Clause 3: The method of Clause 2, further comprising, after reception of the random access response-related message, sending in a second RO of the one or more second ROs: a re-transmission of the first random access signal to initiate a second RACH procedure; or a second random access signal to initiate a second RACH procedure.

Clause 4: The method of Clause 3, further comprising: receiving a contention resolution message; and establishing a radio resource control (RRC) connection with a network entity based on the reception of the contention resolution message, wherein adapting the RACH configuration comprises adapting the RACH configuration until the RRC connection is established with the network entity.

Clause 5: The method of any one of Clauses 2-4, wherein adapting the RACH configuration comprises adapting the RACH configuration only for a period of time after reception of the random access response-related message.

Clause 6: The method of any one of Clauses 2-5, further comprising receiving an indication of deactivation of an adaptation associated with the RACH configuration adaptation indication.

Clause 7: The method of any one of Clauses 1-6, wherein the one or more second ROs are different than the one or more first ROs.

Clause 8: The method of any one of Clauses 1-7, wherein the one or more first ROs comprise at least one of the one or more second ROs.

Clause 9: The method of Clause 8, wherein the one or more first ROs comprise all of the one or more second ROs.

Clause 10: The method of any one of Clauses 1-9, wherein the random access response-related message comprises a downlink control information comprising the RACH configuration adaptation indication.

Clause 11: The method of any one of Clauses 1-10, wherein the random access response-related message comprises a random access response comprising the RACH configuration adaptation indication.

Clause 12: The method of Clause 11, wherein the RACH configuration adaptation indication is specified by one or more bits of the random access response.

Clause 13: The method of any one of Clauses 1-12, further comprising: receiving an indication of a plurality of indexes associated with a plurality of adaptations, wherein: the plurality of indexes comprise at least a first index associated with an adaptation associated with the RACH configuration adaptation indication; and the respective index associated with each respective adaptation of the plurality of adaptations is associated with one or more respective ROs; and the RACH configuration adaptation indication comprises an indication of the first index.

Clause 14: The method of Clause 13, wherein receiving the indication of the plurality of indexes comprises receiving the indication of the plurality of indexes in one or more system information messages.

Clause 15: The method of any one of Clauses 13-14, wherein receiving the indication of the plurality of indexes comprises receiving the indication of the plurality of indexes via radio resource control (RRC) signaling.

Clause 16: The method of any one of Clauses 1-15, wherein: the first random access signal is associated with a first synchronization signal block (SSB) index; and the one or more second ROs are associated with the first SSB index.

Clause 17: The method of Clause 16, wherein the one or more second ROs comprise a subset of a plurality of third ROs associated with the first SSB index.

Clause 18: The method of Clause 17, wherein the RACH configuration adaptation indication comprises a random access radio network temporary identity (RA-RNTI) associated with the one or more second ROs.

Clause 19: A method, comprising: sending an indication of a random access channel (RACH) configuration associated with one or more first RACH occasions (ROs); receiving, in a first RO of the one or more first ROs, a first random access signal to initiate a first RACH procedure; and sending a random access response-related message comprising a RACH configuration adaptation indication associated with one or more second ROs.

Clause 20: The method of Clause 19, further comprising: adapting the RACH configuration based on the RACH configuration adaptation indication.

Clause 21: The method of Clause 20, further comprising, after transmission of the random access response-related message, receiving in a second RO of the one or more second ROs: a re-transmission of the first random access signal to initiate a second RACH procedure; or a second random access signal to initiate a second RACH procedure.

Clause 22: The method of Clause 21, further comprising: sending a contention resolution message; and establishing a radio resource control (RRC) connection with a user equipment based on the reception of the contention resolution message; and adapting the RACH configuration, comprises adapting the RACH configuration until the RRC connection is established with the user equipment.

Clause 23: The method of any one of Clauses 20-22, wherein adapting the RACH configuration comprises adapting the RACH configuration only for a period of time after transmission of the random access response-related message.

Clause 24: The method of any one of Clauses 20-23, further comprising sending an indication of deactivation of an adaptation associated with the RACH configuration adaptation indication.

Clause 25: The method of any one of Clauses 19-24, wherein the one or more second ROs are different than the one or more first ROs.

Clause 26: The method of any one of Clauses 19-25, wherein the one or more first ROs comprise at least one of the one or more second ROs.

Clause 27: The method of Clause 26, wherein the one or more first ROs comprise all of the one or more second ROs.

Clause 28: The method of any one of Clauses 19-27, wherein the random access response-related message comprises a downlink control information comprising the RACH configuration adaptation indication.

Clause 29: The method of any one of Clauses 19-28, wherein the random access response-related message comprises a random access response comprising the RACH configuration adaptation indication.

Clause 30: The method of Clause 29, wherein the RACH configuration adaptation indication is specified by one or more bits of the random access response.

Clause 31: The method of any one of Clauses 19-30, further comprising sending an indication of a plurality of indexes associated with a plurality of adaptations, wherein: the plurality of indexes comprise at least a first index associated with an adaptation associated with the RACH configuration adaptation indication; and the respective index associated with each respective adaptation of the plurality of adaptations is associated with one or more respective ROs; and the RACH configuration adaptation indication comprises an indication of the first index.

Clause 32: The method of Clause 31, wherein sending the indication of the plurality of indexes comprises sending the indication of the plurality of indexes in one or more system information messages.

Clause 33: The method of any one of Clauses 31-32, wherein sending the indication of the plurality of indexes comprises sending the indication of the plurality of indexes via radio resource control (RRC) signaling.

Clause 34: The method of any one of Clauses 19-33, wherein: the first random access signal is associated with a first synchronization signal block (SSB) index; and the one or more second ROs are associated with the first SSB index.

Clause 35: The method of Clause 34, wherein the one or more second ROs comprise a subset of a plurality of third ROs associated with the first SSB index.

Clause 36: The method of Clause 35, wherein the RACH configuration adaptation indication comprises a random access radio network temporary identity (RA-RNTI) associated with the one or more second ROs.

Clause 37: One or more apparatuses, comprising: one or more memories comprising executable instructions; and one or more processors configured to execute the executable instructions and cause the one or more apparatuses to perform a method in accordance with any one of clauses 1-36.

Clause 38: One or more apparatuses configured for wireless communications, comprising: one or more memories; and one or more processors, coupled to the one or more memories, configured to cause the one or more apparatuses to perform a method in accordance with any one of Clauses 1-36.

Clause 39: One or more apparatuses configured for wireless communications, comprising: one or more memories; and one or more processors, coupled to the one or more memories, configured to perform a method in accordance with any one of Clauses 1-36.

Clause 40: One or more apparatuses, comprising means for performing a method in accordance with any one of Clauses 1-36.

Clause 41: One or more non-transitory computer-readable media comprising executable instructions that, when executed by one or more processors of one or more apparatuses, cause the one or more apparatuses to perform a method in accordance with any one of Clauses 1-36.

Clause 42: One or more computer program products embodied on one or more computer-readable storage media comprising code for performing a method in accordance with any one of Clauses 1-36.

Clause 43: One or more apparatuses configured for wireless communications, comprising: a processing system that includes one or more processors and one or more memories coupled with the one or more processors, the processing system configured to cause the one or more apparatuses to perform a method in accordance with any one of Clauses 1-36.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising:
one or more memories; and
one or more processors, coupled to the one or more memories, configured to cause the apparatus to:
receive an indication of a random access channel (RACH) configuration associated with one or more first RACH occasions (ROs);
send, in a first RO of the one or more first ROs, a first random access signal to initiate a first RACH procedure; and
receive a random access response-related message comprising a RACH configuration adaptation indication associated with one or more second ROs.

2. The apparatus of claim 1, wherein the one or more processors are configured to cause the apparatus to:
adapt the RACH configuration based on the RACH configuration adaptation indication.

3. The apparatus of claim 2, wherein the one or more processors are configured to cause the apparatus to, after reception of the random access response-related message, send in a second RO of the one or more second ROs:
a re-transmission of the first random access signal to initiate a second RACH procedure; or
a second random access signal to initiate a second RACH procedure.

4. The apparatus of claim 3, wherein:
the one or more processors are configured to cause the apparatus to:
receive a contention resolution message; and
establish a radio resource control (RRC) connection with a network entity based on the reception of the contention resolution message; and
to adapt the RACH configuration, the one or more processors are configured to adapt the RACH configuration until the RRC connection is established with the network entity.

5. The apparatus of claim 2, wherein to adapt the RACH configuration, the one or more processors are configured to adapt the RACH configuration only for a period of time after reception of the random access response-related message.

6. The apparatus of claim 2, wherein the one or more processors are configured to cause the apparatus to receive an indication of deactivation of an adaptation associated with the RACH configuration adaptation indication.

7. The apparatus of claim 1, wherein the one or more second ROs are different than the one or more first ROs.

8. The apparatus of claim 1, wherein the one or more first ROs comprise at least one of the one or more second ROs.

9. The apparatus of claim 8, wherein the one or more first ROs comprise all of the one or more second ROs.

10. The apparatus of claim 1, wherein the random access response-related message comprises a downlink control information comprising the RACH configuration adaptation indication.

11. The apparatus of claim 1, wherein the random access response-related message comprises a random access response comprising the RACH configuration adaptation indication.

12. The apparatus of claim 11, wherein the RACH configuration adaptation indication is specified by one or more bits of the random access response.

13. The apparatus of claim 1, wherein:
the one or more processors are configured to cause the apparatus to receive an indication of a plurality of indexes associated with a plurality of adaptations, wherein:
the plurality of indexes comprise at least a first index associated with an adaptation associated with the RACH configuration adaptation indication; and
the respective index associated with each respective adaptation of the plurality of adaptations is associated with one or more respective ROs; and
the RACH configuration adaptation indication comprises an indication of the first index.

14. The apparatus of claim 13, wherein to receive the indication of the plurality of indexes, the one or more processors are configured to cause the apparatus to receive the indication of the plurality of indexes in one or more system information messages.

15. The apparatus of claim 13, wherein to receive the indication of the plurality of indexes, the one or more processors are configured to cause the apparatus to receive the indication of the plurality of indexes via radio resource control (RRC) signaling.

16. The apparatus of claim 1, wherein:
the first random access signal is associated with a first synchronization signal block (SSB) index; and
the one or more second ROs are associated with the first SSB index.

17. The apparatus of claim 16, wherein the one or more second ROs comprise a subset of a plurality of third ROs associated with the first SSB index.

18. The apparatus of claim 17, wherein the RACH configuration adaptation indication comprises a random access radio network temporary identity (RA-RNTI) associated with the one or more second ROs.

19. An apparatus comprising:
one or more memories; and
one or more processors, coupled to the one or more memories, configured to cause the apparatus to:
send an indication of a random access channel (RACH) configuration associated with one or more first RACH occasions (ROs);
receive, in a first RO of the one or more first ROs, a first random access signal to initiate a first RACH procedure; and
send a random access response-related message comprising a RACH configuration adaptation indication associated with one or more second ROs.

20. A method for wireless communications, comprising:
receiving an indication of a random access channel (RACH) configuration associated with one or more first RACH occasions (ROs);
sending, in a first RO of the one or more first ROs, a first random access signal to initiate a first RACH procedure; and
receiving a random access response-related message comprising a RACH configuration adaptation indication associated with one or more second ROs.
